(19) United States
(12) Patent Application Publication
(10) Pub. No.: US 2015/0106533 A1
(43) Pub. Date: Apr. 16, 2015

(54) COMMUNICATION APPARATUS, METHOD FOR CONTROLLING COMMUNICATION APPARATUS, AND STORAGE MEDIUM

(71) Applicant: CANON KABUSHIKI KAISHA, Tokyo (JP)

(72) Inventor: Fumihide Goto, Tokyo (JP)

(21) Appl. No.: 14/505,912

(22) Filed: Oct. 3, 2014

(30) Foreign Application Priority Data
Oct. 11, 2013 (JP) 2013-214143
Oct. 2, 2014 (JP) 2014-203959

(51) Int. Cl. H04W 8/26; H04L 29/12

(52) U.S. Cl. CPC H04W 8/26; H04L 61/2061
USPC 709/245

(57) ABSTRACT

A communication apparatus comprises a first assignment unit configured to, with respect to a first other communication apparatus that is connected to a wireless network created by the communication apparatus, assign an address based on a first address assignment method; a second assignment unit configured to assign an address to the first other communication apparatus based on a second address assignment method that is different from the first address assignment method; and a control unit configured to perform control such that activation of the first assignment unit is prevented if an address has been assigned to the first other communication apparatus by the second assignment unit.

### BACKGROUND OF THE INVENTION

1. Field of the Invention

The present invention relates to a communication apparatus, a method for controlling a communication apparatus, and a storage medium.

2. Description of the Related Art

Recent years have seen an increase in cases where a wireless LAN client function is installed in an electronic device such as a digital camera and the electronic device is used while connected to another device. Japanese Patent Laid-Open No. 2011-35768 discloses a method of installing a wireless LAN function in a digital camera so as to facilitate image sharing.

Also, it is becoming common for wireless LAN access point functions to be built into electronic devices so that they can directly connect to each other. If a wireless LAN access point function is provided in an electronic device, a DHCP server function is also often included in order to further facilitate IP address assignment.

Also, a standard specification known as Wi-Fi Direct, established by the Wi-Fi Alliance, is described in the Wi-Fi Peer-to-Peer (P2P) Specification v1.2. This specification is for forming a communication group by directly connecting multiple devices and determines whether the devices are to operate as access points or clients when the communication group is formed. After determining operations, various types of parameters necessary for communication are provided from the access point to the clients and are set. In this specification, it is stipulated that DHCP is to be used in IP address assignment.

Also, a standard specification known as Wi-Fi IBSS with Wi-Fi Protected Setup that was similarly established by the Wi-Fi Alliance is described in IBSS with Wi-Fi Protected Setup Technical Specification v1.0.0. In this specification, it is also stipulated that an IP address is to be provided as a communication parameter.

On the other hand, there is a publicly-known method in which communication parameters are set using NFC, USB, or two-dimensional barcode in order to facilitate initial setting of a user. In many cases, the IP address is included in the set communication parameters.

There exist various simple methods for setting communication parameters for connecting electronic devices over a wireless LAN in this way, and there are both cases where the IP address is transmitted as a communication parameter and cases where it is not transmitted.

For this reason, due to the existence of communication parameter provision methods in which the IP address assignment methods are different, there is a problem in that it is possible that consistency in IP addresses on the same network will be lost.

In view of the foregoing problem, the present invention provides a technique for ensuring address consistency even in a system using different address assignment methods.

### SUMMARY OF THE INVENTION

According to one aspect of the present invention, there is provided a communication apparatus comprising: a first assignment unit configured to, with respect to a first other communication apparatus that is connected to a wireless network created by the communication apparatus, assign an address based on a first address assignment method; a second assignment unit configured to assign an address to the first other communication apparatus based on a second address assignment method that is different from the first address assignment method; and a control unit configured to perform control such that activation of the first assignment unit is prevented if an address has been assigned to the first other communication apparatus by the second assignment unit.

Further features of the present invention will become apparent from the following description of exemplary embodiments with reference to the attached drawings.

### BRIEF DESCRIPTION OF THE DRAWINGS

FIG. 1 is a diagram showing an example of a configuration of a communication apparatus according to an embodiment of the present invention.

FIG. 2 is a functional block diagram of software in the communication apparatus according to an embodiment of the present invention.

FIG. 3 is a diagram showing an example of a network configuration according to an embodiment of the present invention.

FIG. 4 is a diagram showing an example of a sequence between communication apparatuses according to a first embodiment of the present invention.

FIG. 5 is a flowchart showing a procedure of processing performed by a communication apparatus A according to the first embodiment of the present invention.

FIG. 6 is a flowchart showing a procedure of processing performed by a communication apparatus B according to the first embodiment of the present invention.

FIG. 7 is a flowchart showing a procedure of processing performed by the communication apparatus B according to a second embodiment of the present invention.

### DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

Hereinafter, a description will be given for an example of using a wireless LAN system that conforms to the IEEE 802.11 series, but the communication mode is not necessarily limited to a wireless LAN that conforms to IEEE 802.11.

### First Embodiment

1. Hardware Configuration of Communication Apparatus

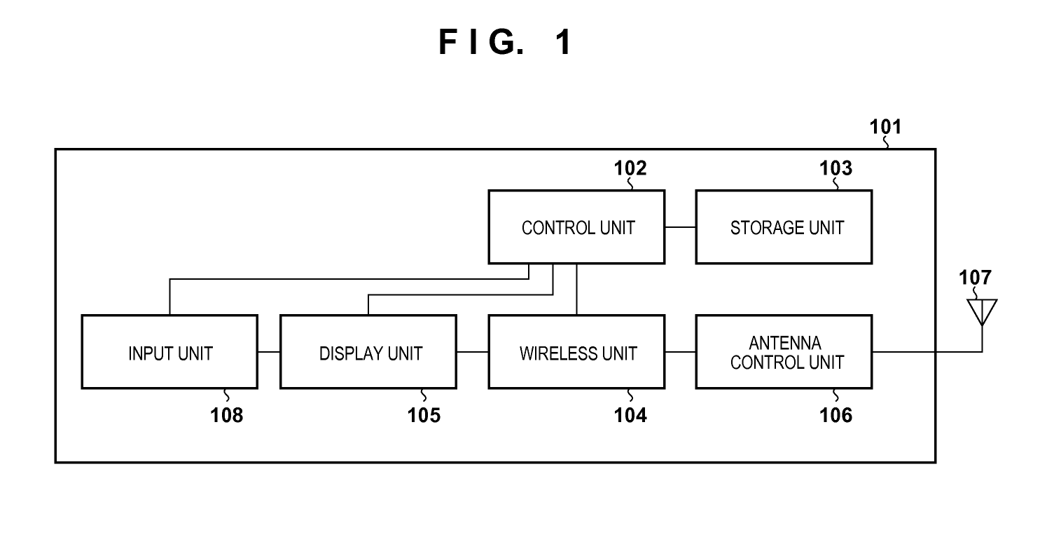

First, an example of a hardware configuration of a communication apparatus according to an embodiment of the present invention will be described with reference to FIG. 1. A communication apparatus 101 includes a control unit 102, a storage unit 103, a wireless unit 104, a display unit 105, an antenna control unit 106, an antenna 107, and an input unit 108.

The control unit 102 performs overall control of the operation of the communication apparatus by executing a control program stored in the storage unit 103. The control unit 102 also controls the setting of communication parameters between the communication apparatus 101 and another communication apparatus. The storage unit 103 stores various types of information such as a control program executed by the control unit 102 and communication parameters. Various types of later-described operations are performed due to the control unit 102 executing the control program stored in the storage unit 103. The wireless unit 104 has a function of performing wireless LAN communication that conforms to the IEEE 802.11 series. The display unit 105 performs various types of display. The display unit 105 has a function by which output of visually perceivable information, as in the case of an LCD or an LED, or audio output, as in the case of a speaker or the like, is possible. The display unit 105 includes a function of outputting at least one of visual information and sound information. The antenna control unit 106 controls the antenna 107. The input unit 108 accepts various types of input from the user.

2. Software Configuration of Communication Apparatus

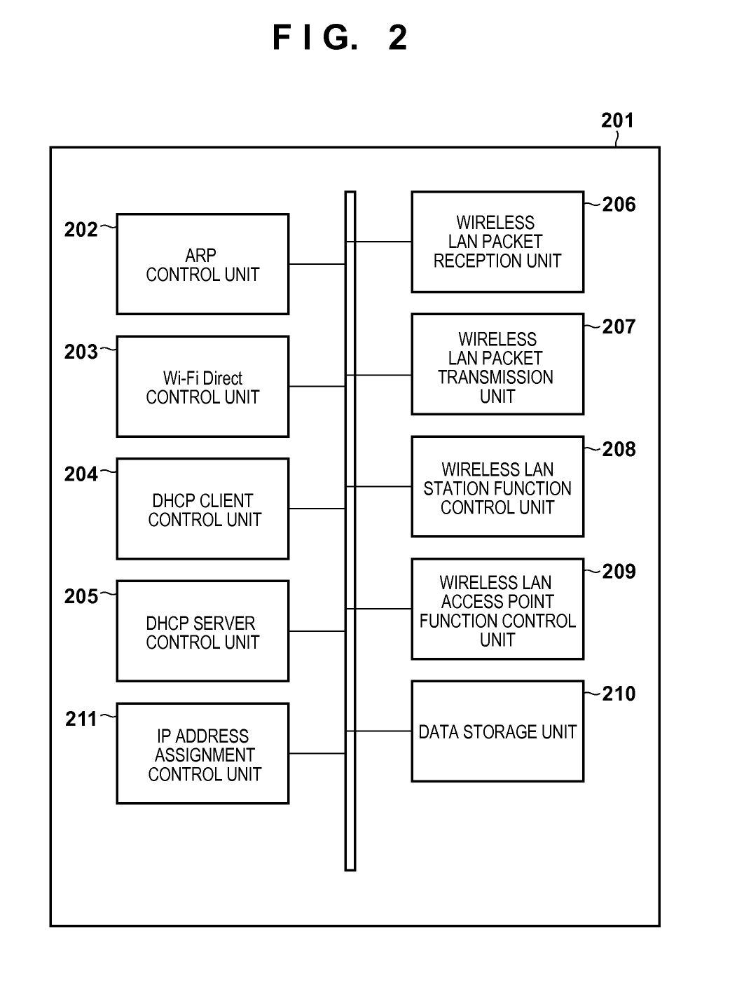

Next, an exemplary software configuration of the communication apparatus according to an embodiment of the present invention will be described with reference to FIG. 2. A later-described communication control function is realized by the software. A communication apparatus 201 is the communication apparatus 101 described from a different aspect and is identical to the communication apparatus 101.

The communication apparatus 201 includes an ARP control unit 202, a Wi-Fi Direct control unit 203, a DHCP client control unit 204, a DHCP server control unit 205, a wireless LAN packet reception unit 206, a wireless LAN packet transmission unit 207, a wireless LAN station function control unit 208, a wireless LAN access point function control unit 209, a data storage unit 210, and an IP address assignment control unit 211.

The ARP control unit 202 controls an ARP protocol. The ARP protocol is a protocol for storing an IP address and a MAC address in association with each other, and is for managing an ARP table, which is a correspondence table.

The Wi-Fi Direct control unit 203 implements various types of processing based on the Wi-Fi Direct specification. With Wi-Fi Direct, the communication apparatus that implements the wireless LAN access point function is referred to as the P2P group owner (referred to below as “GO”), and the communication apparatus that implements the wireless LAN station function (wireless LAN client function) is referred to as the P2P client (referred to below as “CL”). These roles are determined using a protocol for GO Negotiation and are regulated by the Wi-Fi Direct specification (see Wi-Fi Peer-to-Peer (P2P) Specification v1.2). See Wi-Fi Peer-to-Peer (P2P) Specification v1.2 for details. With Wi-Fi Direct, the network established by the GO is referred to as a P2P group.

After the roles of GO and CL have been determined, the Wi-Fi Direct control unit 203 also implements the provision of parameters such as an SSID and an encryption key for communication from the GO to the CL by means of a wireless LAN, based on a WPS protocol. Specifically, the GO causes a WPS registrar function to operate, and the CL causes a WPS enrollee function to operate (regarding WPS protocol, see Wi-Fi Peer-to-Peer (P2P) Specification v1.2 and IBSS with Wi-Fi Protected Setup Technical Specification v1.0.0).

The DHCP client control unit 204 executes a DHCP client function. The DHCP server control unit 205 executes a DHCP server function. The role of the communication apparatus 201 determines whether the DHCP client function is executed or the DHCP server function is executed, and the corresponding processing unit executes an operation. The DHCP server control unit 205 has a DHCP address table, which is a management table for assigned IP addresses. With the Wi-Fi Direct standard, the GO causes the DHCP server function to operate and the CL causes the DHCP client function to operate.

The wireless LAN packet reception unit 206 and the wireless LAN packet transmission unit 207 control transmission and reception of all packets, including upper-layer protocols. The wireless LAN station function control unit 208 implements authentication, encryption processing, and the like at the time when the electronic device operates as a wireless LAN station. The wireless LAN station function control unit 208 operates also at the time when the electronic device operates as a P2P client according to Wi-Fi Direct.

The wireless LAN access point function control unit 209 implements authentication and encryption processing, and management of communication partner apparatuses in the case where the electronic device operates as a wireless LAN access point function. The wireless LAN access point function control unit 209 operates also in the case where the electronic device operates as a P2P group owner according to Wi-Fi Direct.

It is possible to operate one of the functions of the wireless LAN station function control unit 208 and the wireless LAN access point function control unit 209 or to operate both functions at the same time. The data storage unit 210 stores the software program itself and various tables, such as a DHCP address table and an ARP table.

The IP address assignment control unit 211 implements control of IP address assignment according to the present embodiment. The DHCP client control unit 204, the DHCP server control unit 205, and the like are controlled according to instructions from the IP address assignment control unit 211. Also, the IP address assignment control unit 211 also has a function of determining which method has been used or is to be used by the communication partner communication apparatus to assign an IP address.

Note that all functional blocks are related to each other in a software manner or a hardware manner. Also, the above-described functional blocks are examples, and one functional block may be configured by multiple functional blocks, and any functional block may be further divided into blocks for performing multiple functions.

3. Sequence of Processing Between Communication Apparatuses

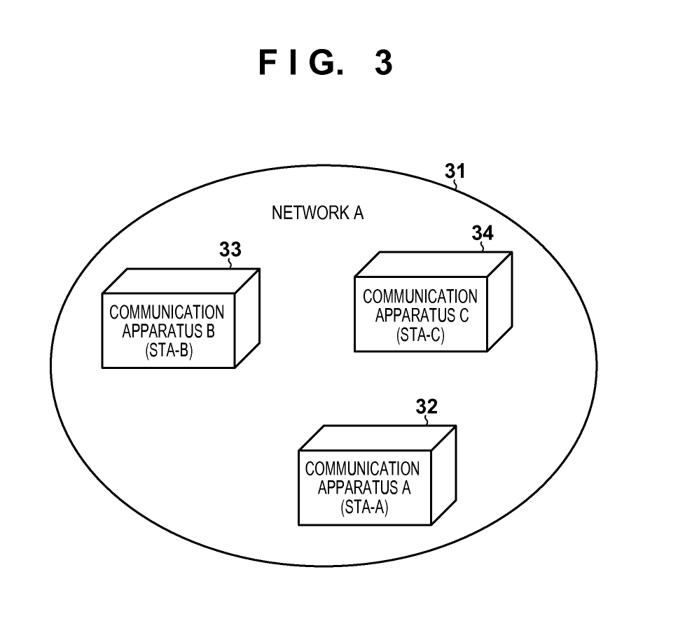

FIG. 3 is a diagram showing a first communication apparatus A32 (referred to below as “STA-A”), a second communication apparatus B33 (referred to below as “STA-B”), a third communication apparatus C34 (referred to below as “STA-C”), and a network A31 (referred to below as “network A”) that includes STA-A, STA-B, and STA-C. All of the communication apparatuses have the above-described configurations of FIGS. 1 and 2.

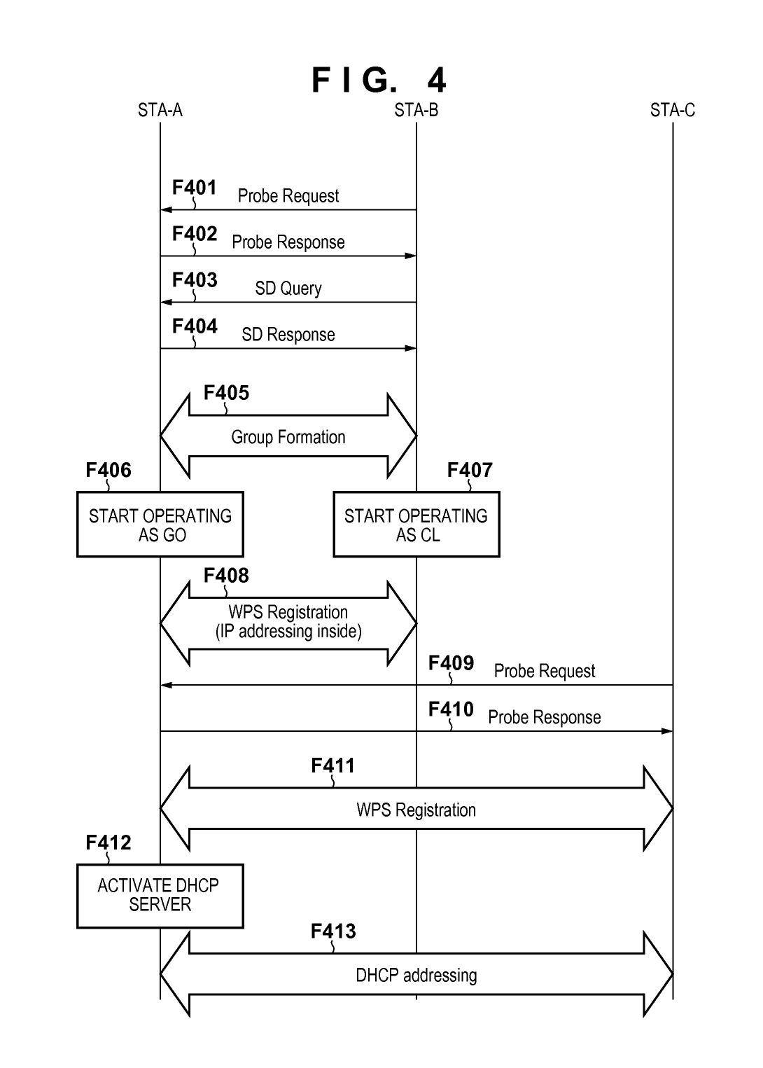

FIG. 4 is a sequence diagram showing an example of processing in the case where STA-B, which has a function of assigning an IP address in a WPS sequence, and STA-C, which has a function of assigning an IP address using the DHCP protocol, are connected to STA-A, which is compatible with both functions. The present embodiment will describe an example of controlling whether or not to activate the DHCP protocol according to the IP address assignment status and the network status.

After receiving a user instruction, STA-B broadcasts a Probe Request signal in order to search for a device that is to be a communication partner (F401). Upon receiving the Probe Request signal, STA-A transmits a Probe Response signal to STA-B as a response (F402). By receiving the Probe Response signal, STA-B can recognize that STA-A exists as an apparatus that is a communication partner candidate.

Thereafter, STA-B transmits an SD Query signal to STA-A in order to find out whether or not the service desired by the user is available (F403). An SD Query signal is a query signal for inquiring whether or not the communication apparatus that is a communication destination provides a desired service. The SD Query signal may be for search processing by means of a wild card designation that searches for all services, and it may be for search processing in which a specific, desired service is targeted. Also, the inquiry by means of SD Query Signal can be implemented before the communication apparatuses are connected by wireless LAN (in the pre-association state).

After receiving the SD Query signal, STA-A transmits an SD Response signal as a response thereto (F404). At the time of transmitting the SD Response signal, STA-A stores the identification information such as the MAC address of STA-B that has transmitted the SD Query signal.

Note that here, an example will be described in which inquiry regarding provided services by means of SD Query signal is performed after searching for communication apparatuses by means of the Probe Request signal. However, an additional information element relating to application-layer services may be added to the Probe Request signal in order to search for services of partner apparatuses as well using only the Probe Request signal. In such a case, there is no need to exchange an SQ Query signal and an SD Response signal. Note that storage of identification information such as mutual MAC addresses is implemented similarly. Also, wireless LAN connection processing may be implemented without exchanging service information in the first place.

After exchanging service information, wireless LAN connection processing is implemented. In the present embodiment, Group Formation processing is implemented in order to implement wireless LAN connection processing based on the Wi-Fi Direct standard (F405).

The present processing is controlled by the Wi-Fi Direct control unit 203. As described above, Group Formation processing is role determination processing for determining which of the two communication apparatuses is to be the GO and which is to be the CL.

As a result of the role determination processing performed by the Wi-Fi Direct control unit 203, STA-A starts to operate as the GO (F406) and STA-B starts to operate as the CL (F407). Thereafter, WPS parameter exchange processing is executed using STA-A as the WPS registrar and STA-B as the WPS enrollee (F408). STA-A and STA-B are not assigned addresses using DHCP since IP address assignment is also performed in WPS parameter exchange processing. Here, control according to which activation of the DHCP server is prevented may be performed if WPS parameter exchange processing is performed using a method other than wireless LAN, such as NFC or Bluetooth (registered trademark).

Note that the present embodiment described an example of assigning IP addresses in WPS parameter exchange processing, but IP address assignment processing may be executed in the Group Formation processing shown in F405, or at any point in the processing sequence of connecting STA-B to STA-A for example, rather than in the WPS parameter exchange sequence. Furthermore, a configuration is possible in which an additional information element regarding IP address assignment is added to the Probe Request signal and the Probe Response signal or in the SD Query signal and the SD Response signal and the IP address assignment method is determined by referencing the additional information element. Also, control according to which address assignment according to DHCP is prevented may be performed also in the case where it is recognized that the IP address has been assigned using NFC or Bluetooth (registered trademark), which are short-range wireless methods, before STA-A and STA-B are connected by a wireless LAN. Furthermore, control according to which IP address assignment according to DHCP is prevented may be performed also in the case where it is recognized that setting and assignment processing of wireless LAN parameters and IP addresses by means of a USB or two-dimensional barcode has been performed without using wireless communication.

In particular, control according to which activation of the DHCP server is prevented may be performed when an IP address has been assigned using a method other than a wireless LAN, such as NFC or Bluetooth (registered trademark).

Note that even if the address is not assigned using DHCP, a setting may be made in the DHCP address table that exists in the data storage unit 210 to indicate that the IP address has been assigned to the partner communication apparatus. According to the present processing, it is possible to prevent a subsequent occurrence of inconsistency at the time of activating a DHCP server function.

Next, a case will be considered in which STA-C, which is a third terminal, joins the network created by STA-A and STA-B.

After receiving a user instruction, STA-C broadcasts a Probe Request signal in order to search for a device that is to be a communication partner (F409).

Upon receiving the Probe Request signal, STA-A transmits a Probe Response signal to STA-C as a response (F410). By receiving the Probe Response signal, STA-B can recognize that STA-A exists as an apparatus that is a communication partner candidate.

Wireless LAN connection processing is implemented thereafter. In the present embodiment, wireless LAN connection processing based on the Wi-Fi Direct specification is implemented, and STA-C starts operating as a CL since STA-A is already operating as the GO.

Accordingly, WPS parameter exchange processing is executed using STA-A as the WPS registrar and STA-C as the WPS enrollee (F411).

STA-A can also perform IP address assignment in WPS parameter exchange processing, but since STA-C, which is a partner apparatus, does not support the function, STA-A activates the DHCP server (F412) and executes address assignment by means of DHCP (F413). Of course, the IP address assigned by STA-A to STA-C is different from the IP address assigned by STA-A to STA-B. Thereafter, the sequence in FIG. 4 ends.

The information regarding the determination as to whether or not IP address assignment is unsupported may be included in the Probe Request signal, the Probe Response signal, or the like, and the determination information may be exchanged in the WPS parameter exchange sequence.

4. Processing Implemented by the Communication Apparatus A32 (STA-A)

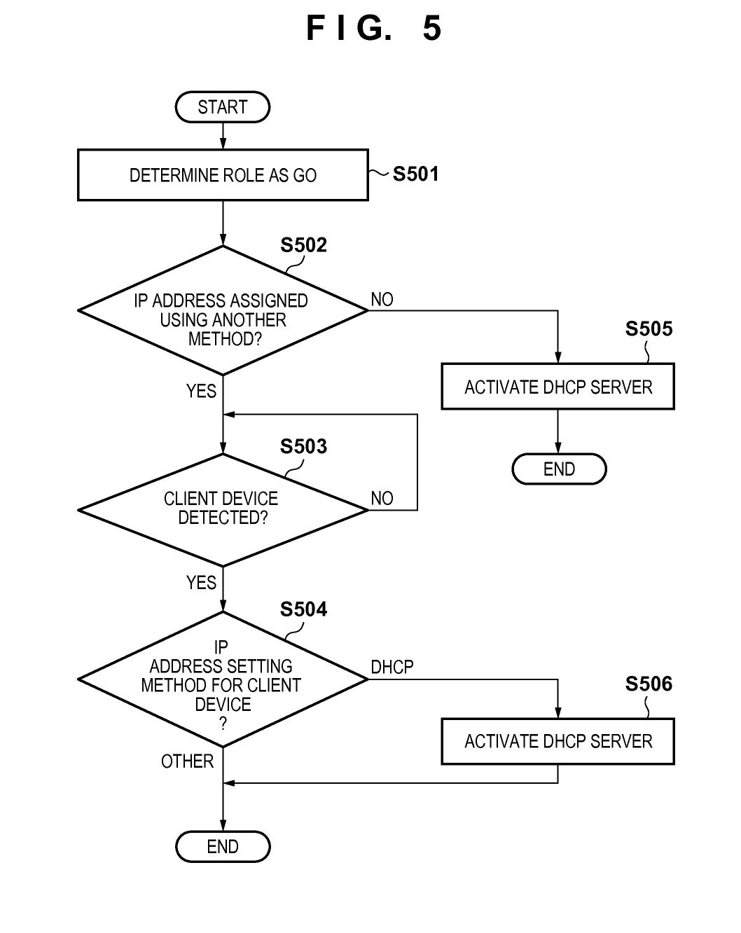

A procedure of processing implemented by STA-A in FIG. 4 will be described below with reference to the flowchart in FIG. 5. As described above, STA-A has both a function of assigning IP addresses in the WPS sequence and a function of assigning an IP address using a DHCP protocol.

First, the role of STA-A is determined as GO using connection processing according to Wi-Fi Direct (step S501). It is determined whether or not a method other than the DHCP protocol has been used to assign an IP address to a communication apparatus (e.g., STA-B) connected to the network created by STA-A (step S502). It is possible to determine whether the DHCP protocol or another method has been used to assign the IP address based on the existence of a request signal from the client device (communication apparatus). Alternatively, identification is possible using various methods such as exchanging specific identifiers in WPS parameter exchange processing, exchanging specific identifiers in Group Formation processing, and exchanging any communication packet.

Also, control according to which address assignment according to DHCP is prevented may be performed also in the case where it is recognized that the IP address has been assigned using NFC or Bluetooth (registered trademark), which are short-range wireless methods, before STA-A and STA-B are connected by a wireless LAN. Furthermore, control according to which address assignment according to DHCP is prevented may be performed also in the case where it is recognized that setting and assignment processing of wireless LAN parameters and IP addresses by means of a USB or two-dimensional barcode, which do not use wireless communication, has been performed.

If it is determined in step S502 that the IP address has not been assigned, the procedure moves to step S505 and a DHCP server function included in STA-A (predetermined address assignment function) is activated as described in the Wi-Fi Direct specification (step S505).

On the other hand, if it is determined in step S502 that the IP address has been assigned using another method, the procedure moves to step S503, and it is determined whether or not a client device (e.g., STA-C) has been detected (step S503). Note that if a client device is not detected, processing waits until it is detected.

If a client device is detected in step S503, the procedure moves to step S504, and the IP address setting method for the detected client device is determined (step S504). If the client device requests IP address assignment by means of DHCP protocol, the procedure moves to step S506 and a DHCP server function included in the STA-A is activated (step S506).

On the other hand, if it is discovered that the client device has already been assigned an IP address using an address assignment method other than DHCP, the processing ends. Examples of address assignment methods other than DHCP include methods other than wireless LAN such as NFC and Bluetooth (registered trademark), as well as assignment methods by means of protocols different from DHCP, such as Auto IP.

Here, when performing IP address assignment using the DHCP server function, there is a possibility that an IP address has been assigned using a method other than a DHCP protocol.

For this reason, when assigning an IP address to a partner communication apparatus by activating a DHCP server function (a predetermined IP address assignment function), an ARP protocol is used in advance to confirm that the IP address that is to be assigned has not already been used for another communication apparatus on the same network, and if it has not been used, the IP address is assigned.

Note that when STA-A has assigned an IP address to a client device using a method other than a DHCP protocol, the IP address may be handled as being statically assigned, and the corresponding IP address may be reserved such that it is not assigned using the DHCP server function.

Also, if a client device that has already been assigned an IP address using a protocol other than the DHCP protocol requests assignment of an IP address by means of DHCP protocol with an IP address designation, it is determined whether or not the IP address has been assigned to the client device using another protocol, and if it is discovered that the IP addresses are the same, the IP address is assigned again using the DHCP protocol, or it is handled as being statically assigned.

Thus, if the IP address has been assigned using an address assignment function other than the DHCP server function, the DHCP server function is not activated, and if another communication apparatus (legacy device) joins thereafter, the DHCP server function is activated. Also, the IP address that is to be assigned at that time is assigned after the ARP protocol is used to confirm in advance that the IP address that is to be assigned has not already been used for another communication apparatus on the same network.

5. Processing Implemented by the Communication Apparatus B33 (STA-B)

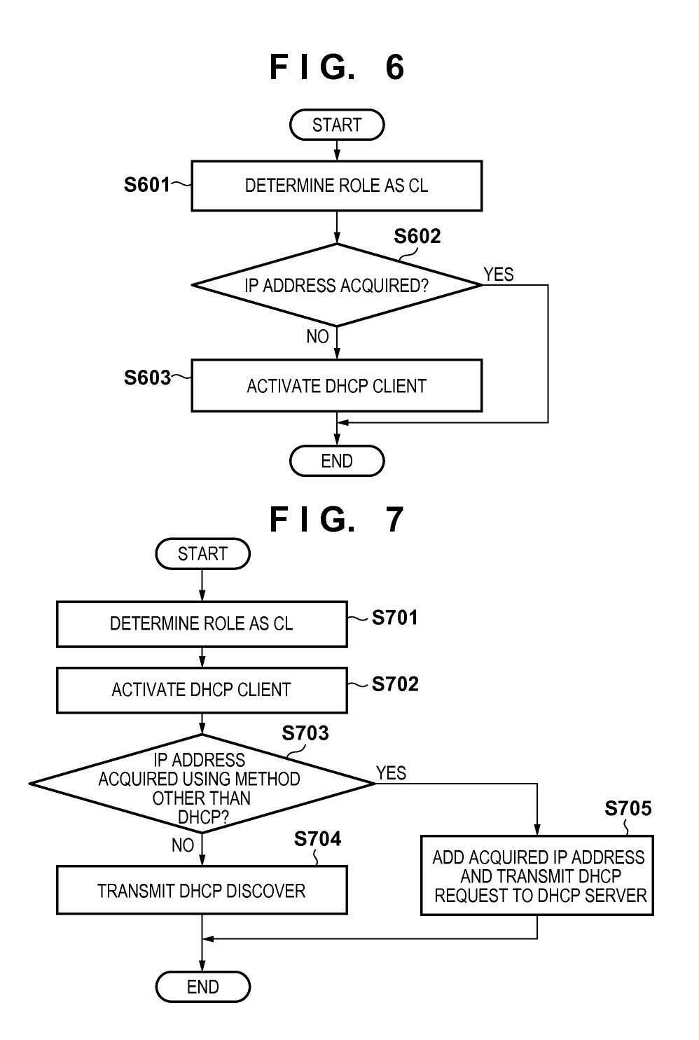

Next, a procedure of processing implemented by STA-B in FIG. 4 will be described below with reference to the flowchart in FIG. 6. As described above, STA-B has both a function of assigning an IP address in the WPS sequence and a function of assigning an IP address using the DHCP protocol.

First, the role of STA-B is determined as CL using the connection processing according to Wi-Fi Direct (step S601). Next, it is determined whether or not an IP address has been assigned using a method other than the DHCP protocol (step S602). If it is determined that an IP address has not been assigned, the procedure moves to step S603, and a DHCP client function included in STA-B is activated as described in the Wi-Fi Direct specification (step S603).

In the case where the DHCP client function is activated but there is no response from the terminal that is the DHCP server, error display is performed on the display unit 105, and processing ends, or the user is asked whether or not processing is to be continued.

On the other hand, in the determination in step S602, if it is determined that the IP address has already been assigned using another method, no more setting processing is required, and therefore the processing ends. At this time, the DHCP client function is not activated.

As described above, in the present embodiment, if an address assignment function other than a predetermined address assignment function (DHCP server function) has not been used to assign an address to a second communication apparatus (STA-B) that is connected to a network created by a communication apparatus (STA-A) that includes the predetermined address assignment function (DHCP server function), the predetermined address assignment function (DHCP server function) is activated. On the other hand, if an address has been assigned to the second communication apparatus (STA-B) using the other address assignment function, control is performed such that activation of the predetermined address assignment function (DHCP server function) is prevented.

Accordingly, it is possible to prevent redundant IP addresses from being generated when communication apparatuses are directly connected, and it is possible to ensure consistency in the IP address also in a system using different IP address assignment methods.

### Second Embodiment

The present embodiment describes processing that is different from the processing implemented by the communication apparatus B33 (STA-B) that was described in the first embodiment with reference to FIG. 6.

Processing implemented by communication apparatus B33 (STA-B)

Next, a procedure of processing implemented by STA-B in FIG. 4 according to the second embodiment will be described below with reference to the flowchart in FIG. 7. As described above, STA-B has both a function of assigning an IP address in the WPS sequence and a function of assigning an IP address using the DHCP protocol.

Similarly to FIG. 6, the role of STA-B is determined as CL using the connection processing by means of Wi-Fi Direct (step S701). Next, the DHCP client function included in STA-B is activated as described in the Wi-Fi Direct specification (step S702).

The DHCP client function is activated, and after the function is activated, it is determined whether or not the IP address has already been acquired using a method other than the DHCP protocol (step S703). If it has not yet been acquired, DHCP DISCOVER is transmitted in order to search for the DHCP server (step S704). Thereafter, IP addressing processing is implemented according to a normal DHCP protocol sequence.

On the other hand, if the IP address has been acquired in step S703, the acquired IP address is added to the DHCP REQUEST, and a request to assign an IP address is implemented to the DHCP server (step S705). According to this action, it is possible to update information in the DHCP server, and it is possible to prevent inconsistencies from being generated in the IP address on the DHCP server side. If a different IP address has been assigned as a result of the query to the DHCP server, the IP address of STA-B may be updated, or it may be deemed that a problem occurred in the network and wireless communication may be cut off. In the case where the DHCP client function is activated but there is no response from the terminal that is the DHCP server, error display is performed on the display unit 105, and the processing ends, or the user is asked whether or not to continue the processing.

According to the present invention, it is possible to ensure consistency in addresses also in a system that uses different address assignment methods.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2013-214143, filed Oct. 11, 2013, and 2014-203959, filed Oct. 2, 2014, which are hereby incorporated by reference herein in their entirety.

What is claimed is:

1. A communication apparatus comprising:
a first assignment unit configured to, with respect to a first other communication apparatus that is connected to a wireless network created by the communication apparatus, assign an address based on a first address assignment method;
a second assignment unit configured to assign an address to the first other communication apparatus based on a second address assignment method that is different from the first address assignment method; and
a control unit configured to perform control such that activation of the first assignment unit is prevented if an address has been assigned to the first other communication apparatus by the second assignment unit.

2. The communication apparatus according to claim 1,
wherein if an address has not been assigned to the first other communication apparatus by the second assignment unit, the control unit activates the first assignment unit.

3. The communication apparatus according to claim 1, further comprising:
a detection unit configured to detect a second other communication apparatus,
wherein if assignment of an address by means of the first assignment method has been requested by the second other communication apparatus detected by the detection unit to the communication apparatus, the control unit activates the first assignment unit.

4. The communication apparatus according to claim 1, further comprising:
a checking unit configured to, when an address is to be assigned by the first assignment unit to the first other communication apparatus, check whether or not the address that is to be assigned is an address that has been used by another communication apparatus on the wireless network.

5. The communication apparatus according to claim 4,
wherein with respect to the first other communication apparatus, the first assignment unit assigns an address that is different from the address used by the other communication apparatus on the wireless network.

6. The communication apparatus according to claim 1,
wherein the first assignment method is a method that conforms to DHCP (Dynamic Host Configuration Protocol).

7. A method for controlling a communication apparatus, the method comprising:
a first assignment step in which, with respect to a first other communication apparatus that is connected to a wireless network created by the communication apparatus, a first assignment unit assigns an address based on a first address assignment method;
a second assignment step in which a second assignment unit assigns an address to the first other communication apparatus based on a second address assignment method that is different from the first address assignment method; and
a control step in which a control unit performs control such that activation of the first assignment unit is prevented if an address has been assigned to the first other communication apparatus by the second assignment unit.

8. A non-transitory computer-readable storage medium storing a computer program for causing a communication apparatus to function as:
a first assignment unit configured to, with respect to a first other communication apparatus that is connected to a wireless network created by the communication apparatus, assign an address based on a first address assignment method;
a second assignment unit configured to assign an address to the first other communication apparatus based on a second address assignment method that is different from the first address assignment method; and
a control unit configured to perform control such that activation of the first assignment unit is prevented if an address has been assigned to the first other communication apparatus by the second assignment unit.
